(19) United States
(12) Patent Application Publication
(10) Pub. No.: US 2019/0258620 A1
(43) Pub. Date: Aug. 22, 2019

(54) DATA MANAGEMENT APPARATUS AND COMPUTER READABLE MEDIUM

(71) Applicant: MITSUBISHI ELECTRIC CORPORATION, Tokyo (JP)

(72) Inventors: Yoko ITADO, Tokyo (JP); Takeshi TAKEUCHI, Tokyo (JP); Satoshi KAEDE, Tokyo (JP)

(73) Assignee: MITSUBISHI ELECTRIC CORPORATION, Tokyo (JP)

(21) Appl. No.: 16/333,638

(22) PCT Filed: Nov. 14, 2016
(86) PCT No.: PCT/JP2016/083667

§ 371 Date: Mar. 15, 2019

(51) Int. Cl. G06F 16/22; B61L 27/00; G06F 16/28

(52) U.S. Cl. CPC G06F 16/2282; G06F 16/285; G06F 16/221; B61L 27/0011

(57) ABSTRACT

A data management apparatus writes data collected concerning equipment mounted on a railroad vehicle, which is a moving body that repeatedly moves on the same route, during movement of the railroad vehicle into a time-series table. The data management apparatus classifies data stored in the time-series table into a plurality of groups based on a movement location of the railroad vehicle taken when the data was collected. The data management apparatus writes pieces of data classified into the respective groups into a converted table for every group.

### TECHNICAL FIELD

The present invention relates to a management technique for data collected concerning equipment mounted on a moving body which repeatedly moves on the same route, such as a railroad vehicle.

### BACKGROUND ART

Railroad business operators and railroad vehicle equipment manufacturers have been installing sensors in equipment mounted on railroad vehicles and are thus collecting operation data obtained during running of the railroad vehicles and utilizing the collected operation data for preventive maintenance.

In analyzing the collected operation data, pieces of data are extracted with a search condition including the condition that the location in which railroad vehicles are running is the same, and are compared with each other. This leads to analyzing a performance variation over long periods of time. Here, since the number of operating years of equipment spans long periods of time such as 10 years or more, the number of pieces of data to be targeted for analysis may reach several billions. Therefore, a mechanism for efficiently extracting pieces of data from the accumulated data becomes required.

In Patent Literature 1, a technique is described which separates a table in a database for every column into blocks each having a flag indicating whether sorting is finished and then integrates the blocks into a sorting state at predetermined timing. This attempts to speed up search processing for a database.

### CITATION LIST

### Patent Literature

Patent Literature 1: JP-A-2011-209807

### SUMMARY OF INVENTION

### Technical Problem

Data collected concerning equipment is collected and stored in a time series manner. Therefore, data is located in a database in order of date and time. Accordingly, with regard to a moving body which repeatedly moves in the same location, pieces of data obtained when the moving body moved in the same section are located in a dispersed manner. This may cause a range required to be referenced during searching to extend over the overall rows in the database, thus lengthening processing time.

In the technique described in Patent Literature 1, managing the sorting state with separation into blocks being performed for every column enables searching for information included in a specific column at high speed. However, to analyze data concerning running in the same location, it is necessary to perform narrowing down with use of a combination of a column indicating the location and a column targeted for analysis. On the other hand, in the method described in Patent Literature 1, since only processing for each individual column is performed, it is impossible to perform data search using an association with the value of another column at high speed.

The present invention has an object to enable appropriately managing data collected concerning equipment mounted on a moving body which repeatedly moves on the same route.

### Solution to Problem

A data management apparatus according to the present invention includes:

a data classification unit to classify pieces of data collected concerning equipment mounted on a moving body, which repeatedly moves on a same route, during movement of the moving body and then stored in a time-series table into a plurality of groups based on a movement location of the moving body taken when the pieces of data were collected; and

a data write unit to write the pieces of data classified into the respective groups by the data classification unit into a converted table for every group.

### Advantageous Effects of Invention

In the present invention, data is classified into a plurality of groups based on a movement location of a moving body taken when the data was collected, and pieces of data classified into the respective groups are written into a converted table on a group by group basis. This enables appropriately managing data collected concerning equipment mounted on a moving body which repeatedly moves on the same route.

### BRIEF DESCRIPTION OF DRAWINGS

FIG. 1 is a configuration diagram of a data management apparatus 10 according to an embodiment 1.

FIG. 2 is a flowchart of data acquisition processing according to the embodiment 1.

FIG. 3 is a diagram illustrating data stored in a time-series table 131 according to the embodiment 1.

FIG. 4 is a flowchart of data conversion processing according to the embodiment 1.

FIG. 5 is a diagram illustrating data stored in an index table 133 according to the embodiment 1.

FIG. 6 is a diagram illustrating data stored in a converted table 132 according to the embodiment 1.

FIG. 7 is a flowchart of data search processing according to the embodiment 1.

FIG. 8 is a configuration diagram of a data management apparatus 10 according to a modification example 1.

FIG. 9 is a configuration diagram of a data management apparatus 10 according to an embodiment 2.

FIG. 10 is a configuration diagram of a data management apparatus 10 according to an embodiment 3.

FIG. 11 is a configuration diagram of a data management apparatus 10 according to an embodiment 4.

### DESCRIPTION OF EMBODIMENTS

### Embodiment 1

An embodiment 1 is described with use of a railroad vehicle 100 serving as an example of a moving body which repeatedly moves on the same route. The moving body which repeatedly moves on the same route is not limited to the railroad vehicle 100, but can be another type, such as a boat or ship, aircraft, or automobile.

***Description of Configuration***

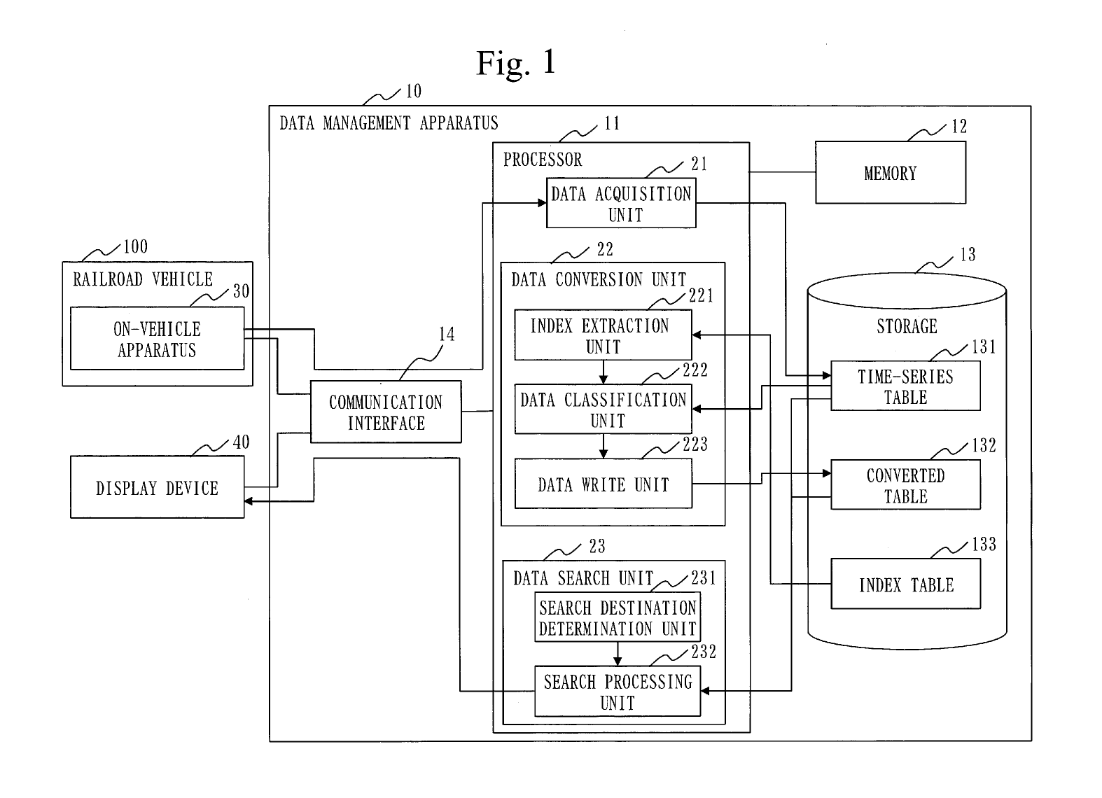

A configuration of a data management apparatus 10 according to the embodiment 1 is described with reference to FIG. 1.

The data management apparatus 10 is a computer which is not mounted on the railroad vehicle 100 serving as a moving body and which is provided separately from the railroad vehicle 100.

The data management apparatus 10 includes pieces of hardware, such as a processor 11, a memory 12, a storage 13, and a communication interface 14. The processor 11 is connected to the other pieces of hardware via signal lines and controls such other pieces of hardware.

The processor 11 is an integrated circuit (IC) which performs processing. Specific examples of the processor 11 include a central processing unit (CPU), a digital signal processor (DSP), and a graphics processing unit (GPU).

The memory 12 is a storage device which temporarily stores data. Specific examples of the memory 12 include a static random access memory (SRAM) and a dynamic random access memory (DRAM).

The storage 13 is a storage device which retains data. Specific examples of the storage 13 include a hard disk drive (HDD). Moreover, the storage 13 can be a portable storage medium, such as a secure digital (SD) memory card, CompactFlash (CF), NAND flash, a flexible disk, an optical disc, a compact disc, a Blu-ray (registered trademark) disc, or a digital versatile disc (DVD).

The communication interface 14 is an interface used to communicate with external apparatuses, such as an on-vehicle apparatus 30, which is mounted on the railroad vehicle 100, and a display device 40. Specific examples of the communication interface 14 include ports of Ethernet (registered trademark), Universal Serial Bus (USB), and High-Definition Multimedia Interface (HDMI, registered trademark).

The on-vehicle apparatus 30 is a computer which collects data concerning equipment mounted on the railroad vehicle 100 during running of the railroad vehicle 100 on an as-needed basis and transmits the collected data to the data management apparatus 10. The data concerning equipment is, for example, data measured by the equipment or data detected by, for example, a sensor, with respect to the equipment.

The display device 40 is a device which displays, for example, data transmitted from the on-vehicle apparatus 30. Specific examples of the display device 40 include a liquid crystal display (LCD).

The data management apparatus 10 includes, as functional constituent elements, a data acquisition unit 21, a data conversion unit 22, and a data search unit 23. The data conversion unit 22 includes an index extraction unit 221, a data classification unit 222, and a data write unit 223. The data search unit 23 includes a search destination determination unit 231 and a search processing unit 232. The function of each of the units including the data acquisition unit 21, the data conversion unit 22, the data search unit 23, the index extraction unit 221, the data classification unit 222, the data write unit 223, the search destination determination unit 231, and the search processing unit 232 is implemented by software.

The storage 13 has stored therein a program for implementing the function of each unit of the data management apparatus 10. This program is loaded into the memory 12 by the processor 11 and is then executed by the processor 11. This implements the function of each unit of the data management apparatus 10. Moreover, the storage 13 stores a time-series table 131, a converted table 132, and an index table 133.

In FIG. 1, the processor 11 is illustrated as only one processor. However, the data management apparatus 10 can include a plurality of processors in substitution for the processor 11. Such a plurality of processors shares execution of the program for implementing the function of each unit of the data management apparatus 10. Each processor is an IC which performs processing, as with the processor 11.

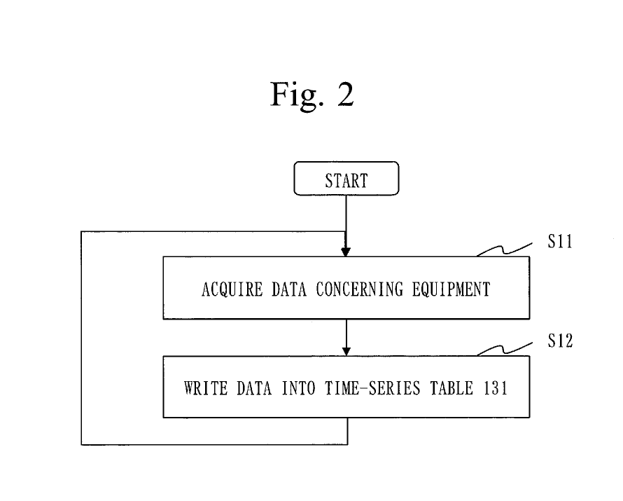

An operation of the data management apparatus 10 according to the embodiment 1 is described with reference to FIG. 2 to FIG. 7.

The operation of the data management apparatus 10 according to the embodiment 1 is equivalent to a data management method according to the embodiment 1. Moreover, the operation of the data management apparatus 10 according to the embodiment 1 is equivalent to processing performed by a data management program according to the embodiment 1.

The operation of the data management apparatus 10 according to the embodiment 1 is broadly divided into data acquisition processing, data conversion processing, and data search processing.

The data acquisition processing according to the embodiment 1 is described with reference to FIG. 2.

The data acquisition processing is repeatedly performed during running of the railroad vehicle 100.

(Step S11: Data Collection Processing)

The on-vehicle apparatus 30 collects data concerning equipment mounted on the railroad vehicle 100 during running of the railroad vehicle 100 and transmits the collected data to the data management apparatus 10. Then, the data acquisition unit 21 acquires the data transmitted from the on-vehicle apparatus 30.

The data includes data indicating a movement location in which the railroad vehicle 100 was moving when the data was collected. Here, the data indicating a movement location includes a railroad business operator, a line section, a track number, a movement direction (upbound or downbound), a route version, and a kilometrage.

(Step S12: Data Write Processing)

The data acquisition unit 21 writes the data acquired in step S11 into the time-series table 131.

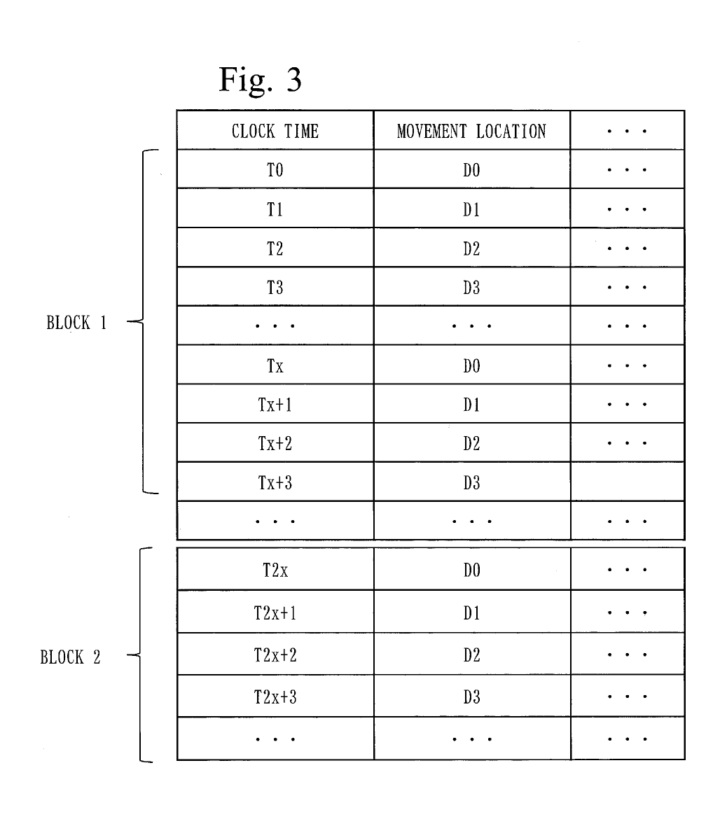

As illustrated in FIG. 3, since data is written into the time-series table 131 in the order the data was acquired, data is stored while being arranged in time-series order. Accordingly, irrespective of movement locations of the railroad vehicle 100, data is divided into blocks for every reference number of pieces of data based on clock times at which the respective pieces of data were acquired.

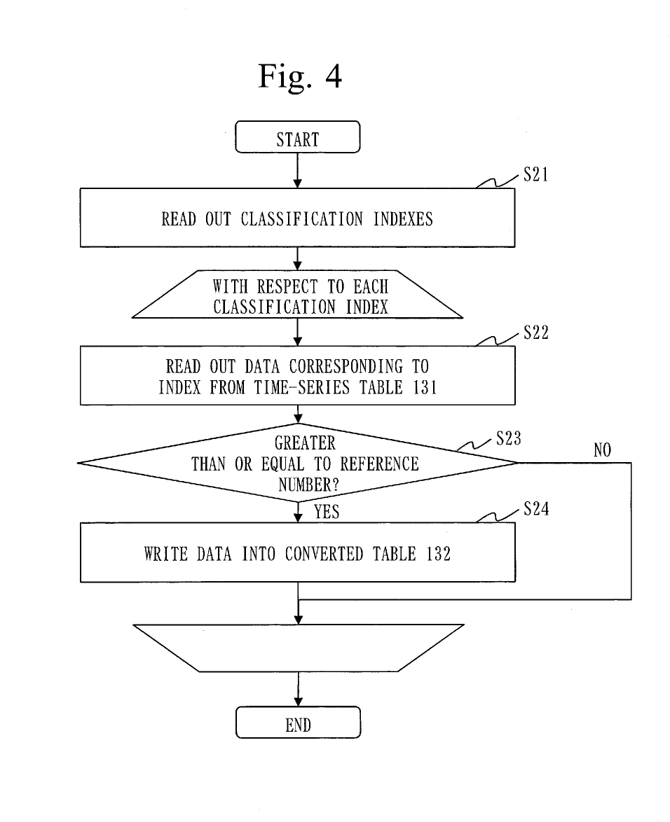

The data conversion processing according to the embodiment 1 is described with reference to FIG. 4.

The data conversion processing is performed on a periodic basis. As a specific example, the data conversion processing is performed when the load on the data management apparatus 10 is low, for example, during the night.

(Step S21: Index Extraction Processing)

The index extraction unit 221 reads out classification indexes from the index table 133.

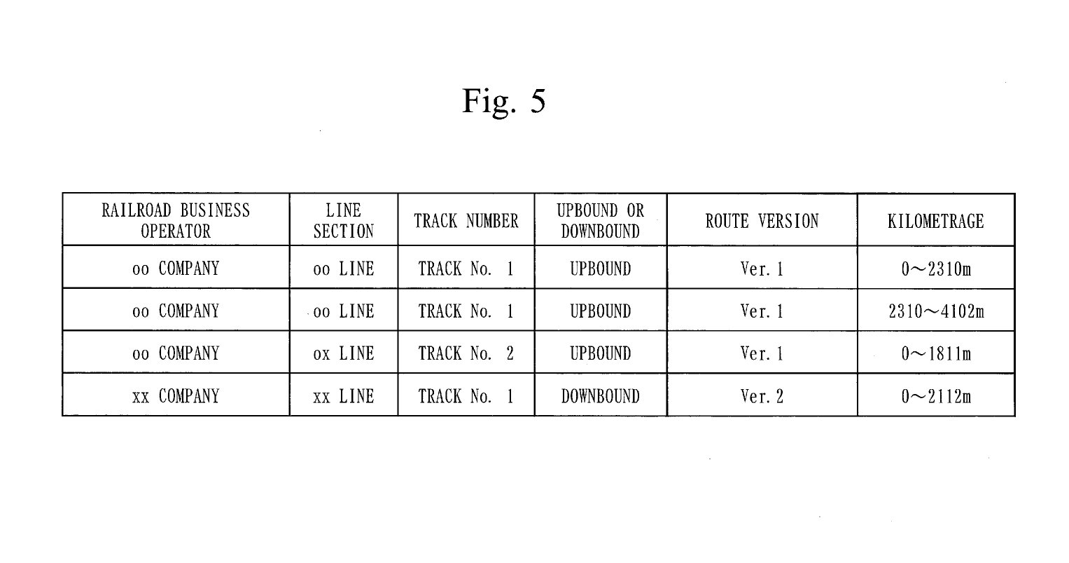

In the embodiment 1, the classification indexes are treated as line section data. As illustrated in FIG. 5, the line section data is data indicating a movement location of the railroad vehicle 100 and is data including a railroad business operator, a line section, a track number, a movement direction (upbound or downbound), a route version, and a kilometrage. The line section data can be not all of the above pieces of data but a part of the pieces of data.

The railroad business operator represents a business operator which manages the running section. The line section, the track number, the movement direction (upbound or downbound), the route version, and the kilometrage are information which is managed by the railroad business operator.

The line section is a unit representing a section of the route, and is a section delimited by separation of the route caused by, for example, entry into the route. The track number is set in a line section other than single-track lines, and represents what number-th track the track is among tracks which are set as the same line section. Furthermore, even in the same line section, lengths may differ depending on track numbers, so that reference values such as kilometrages may differ. The movement direction represents whether, on the track, running was performed in an upbound direction or running was performed in a downbound direction. The route version represents a version which is changed due to, for example, the addition of a station, the extension of the track, or the disuse of the track. The kilometrage is a value representing how many kilometers the point is distant from the point of origin in the line section and is a value which is able to indicate a movement location in the line section.

Furthermore, the line section data can be set in such a way as to cover all of the movement locations, or data which is not indicated by the line section data can be classified as data unindicated by line section data. The index table 133 is re-set each time the line section data is updated.

The conceivable method of detecting updating of the line section data includes, in a case where a railroad business operator builds up the data management apparatus 10, a method of detecting whether the line section data has been updated by a maintenance system of the railroad business operator. Moreover, in a case where a railroad vehicle equipment manufacturer builds up the data management apparatus 10, a method of detecting whether line section data supplied from a railroad business operator as numerical values required for designing or manufacturing of railroad vehicle equipment has been changed can be conceivable.

Next, processing in step S22 to step S24 is performed with each classification index read out in step S21 used as a target index. In other words, processing in step S22 to step S24 is performed with respect to each piece of line section data.

(Step S22: Data Classification Processing)

The data classification unit 222 reads out data corresponding to the target index from the time-series table 131, and classifies the read-out data into a group corresponding to the target index. In other words, the data classification unit 222 reads out data collected during running at the movement location indicated by the target index, and classifies the read-out data into a group corresponding to such a movement location.

The data classification unit 222 writes the classified data into a primary table in the memory 12.

(Step S23: Number-of-Pieces-of-Data Determination Processing)

The data write unit 223 determines whether the number of pieces of data classified into a group corresponding to the target index in step S22 and written into the primary table is greater than or equal to a reference number. The number of pieces of data can be identified by a method of using a COUNT function which is provided as the function of a database.

The reference number is previously determined by the performance, such as a memory and the number of parallelizable processes, of a database to be used. While it is not necessary to change the reference number during operation of the data management apparatus 10, in a case where the performance of the database is changed due to, for example, scale out, the reference number is also changed.

If the number of pieces of data is greater than or equal to the reference number, the data write unit 223 advances the processing to step S24, and, if not, the data write unit 223 advances the processing in such a way as to skip step S24.

(Step S24: Data Write Processing)

The data write unit 223 reads out, from the primary table, data, the number of pieces of which is the reference number, classified into a group corresponding to the target index in step S22, and writes the read-out data as one block for each group into the converted table 132. The data write unit 223 deletes the read-out data from the primary table. On this occasion, with respect to the target index, the write date and time at which data was written into the converted table 132 is stored as a write point of time in the converted table 132.

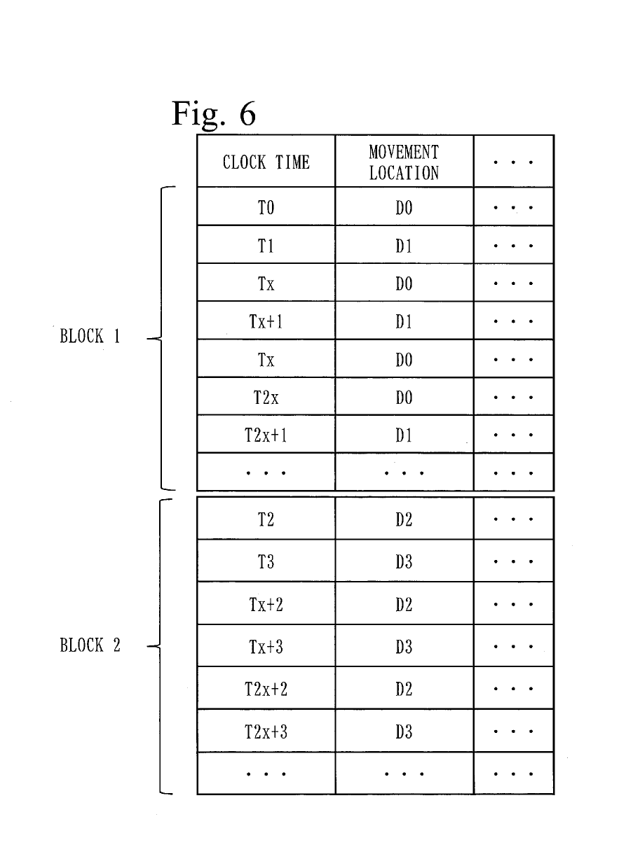

This causes data to be divided into blocks for every movement location. In FIG. 6, a movement location DO and a movement location D1 are assumed to correspond to the same line section data, and a movement location D2 and a movement location D3 are assumed to correspond to the same line section data. Therefore, in FIG. 6, pieces of data about the movement location DO and the movement location D1 are classified into the same block, and pieces of data about the movement location D2 and the movement location D3 are classified into the same block.

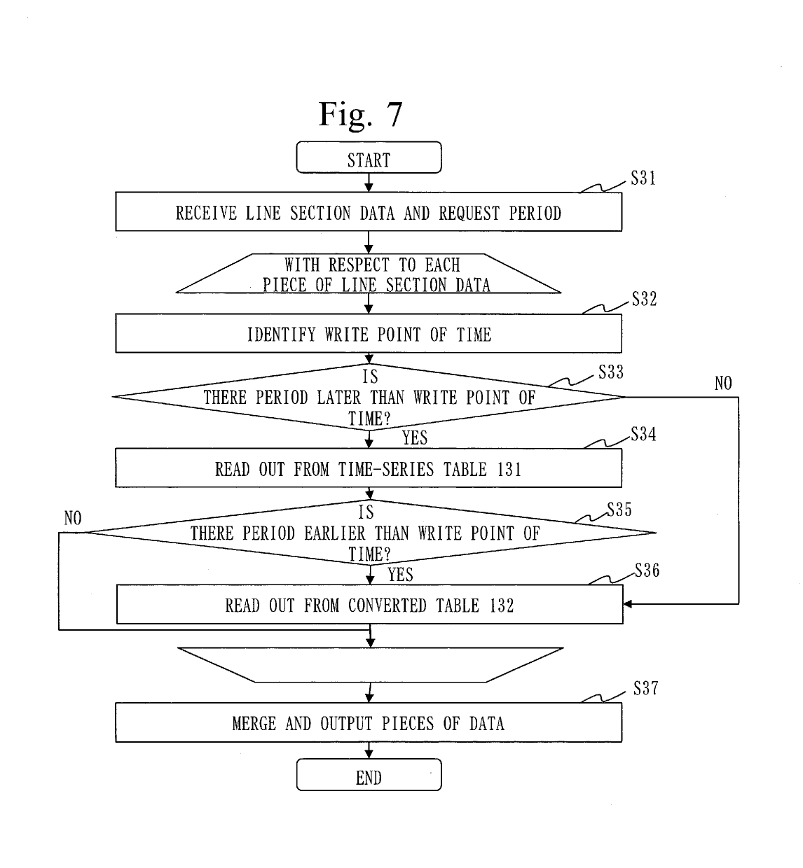

The data search processing according to the embodiment 1 is described with reference to FIG. 7.

The data search processing is performed in a case where a request has been received from a user or another system.

(Step S31: Condition Reception Processing)

The search destination determination unit 231 receives line section data and a request period for data, as a search condition for data.

For a specific example, the search destination determination unit 231 can receive line section data and a request period for data via an input device, or can receive line section data and a request period for data from an external apparatus via the communication interface 14.

As the line section data, all of the railroad business operator, the line section, the track number, the movement direction (upbound or downbound), the route version, and the kilometrage can be specified or only a part of them can be specified. Moreover, a plurality of values can be specified with respect to each piece of data. For a specific example, as a railroad business operator, a plurality of business operators can be specified as OO Company and XX Company. Moreover, each of the route version and the kilometrage can be specified by a range.

In a case where a plurality of pieces of line section data is specified, processing in step S32 to step S36 is performed with each piece of line section data used as a target index.

(Step S32: Write-Point-of-Time Acquisition Processing)

The search destination determination unit 231 reads out a write point of time regarding the target index from the converted table 132.

(Step S33: First Period Determination Processing)

If a period later than the write point of time read out in step S32 is included in the request period received in step S31, the search destination determination unit 231 advances the processing to step S34, and, if not, the search destination determination unit 231 advances the processing to step S36.

(Step S34: First Data Search Processing)

The search processing unit 232 searches the time-series table 131 to read out data which corresponds to the line section data received in step S31 and which is included in the request period. The search processing unit 232 writes the read-out data into the primary table in the memory 12.

(Step S35: Second Period Determination Processing)

If a period earlier than the write point of time read out in step S32 is included in the request period received in step S31, the search destination determination unit 231 advances the processing to step S36, and, if not, the search destination determination unit 231 advances the processing in such a way as to skip step S36.

(Step S36: Second Data Search Processing)

The search processing unit 232 searches the converted table 132 to read out data which corresponds to the line section data received in step S31 and which is included in the request period. The search processing unit 232 writes the read-out data into the primary table in the memory 12.

(Step S37: Data Output Processing)

The search processing unit 232 merges pieces of data written into the primary table in step S34 and step S36, and outputs the merged pieces of data to the display device 40. Merging pieces of data refers to making pieces of data into one data string. Furthermore, pieces of data can be merged for every piece of line section data.

This causes data matching the search condition received in step S31 to be displayed on the display device 40.

### Advantageous Effects of Embodiment 1

As described above, in the data management apparatus 10 according to the embodiment 1, data is classified into a plurality of groups based on movement locations, and pieces of data belonging to the same group are located at near positions on a database. In particular, in the data management apparatus 10 according to the embodiment 1, data is divided into and located as different blocks based on movement locations. Therefore, pieces of data associated with the same movement location are able to be efficiently read out. This enables efficiently performing statistical processing using an enormous amount of data and thus enables efficiently performing analysis of long-term performance variation.

Moreover, in the data management apparatus 10 according to the embodiment 1, since the number of pieces of data differs for each piece of line section data, which is a classification index, the timing of writing to the converted table 132 is determined for each piece of line section data. This enables unifying the sizes of the respective blocks, so that data can be efficiently read out.

Moreover, in the data management apparatus 10 according to the embodiment 1, the destination for readout of data is determined by the search destination determination unit 231. This eliminates the necessity for the user to become conscious of the destination for readout of data.

### Other Configurations

### Modification Example 1

In the embodiment 1, the functions of the respective units of the data management apparatus 10 are implemented by software. However, as a modification example 1, the functions of the respective units of the data management apparatus 10 can be implemented by hardware. This modification example 1 is described with respect to differences from those in the embodiment 1.

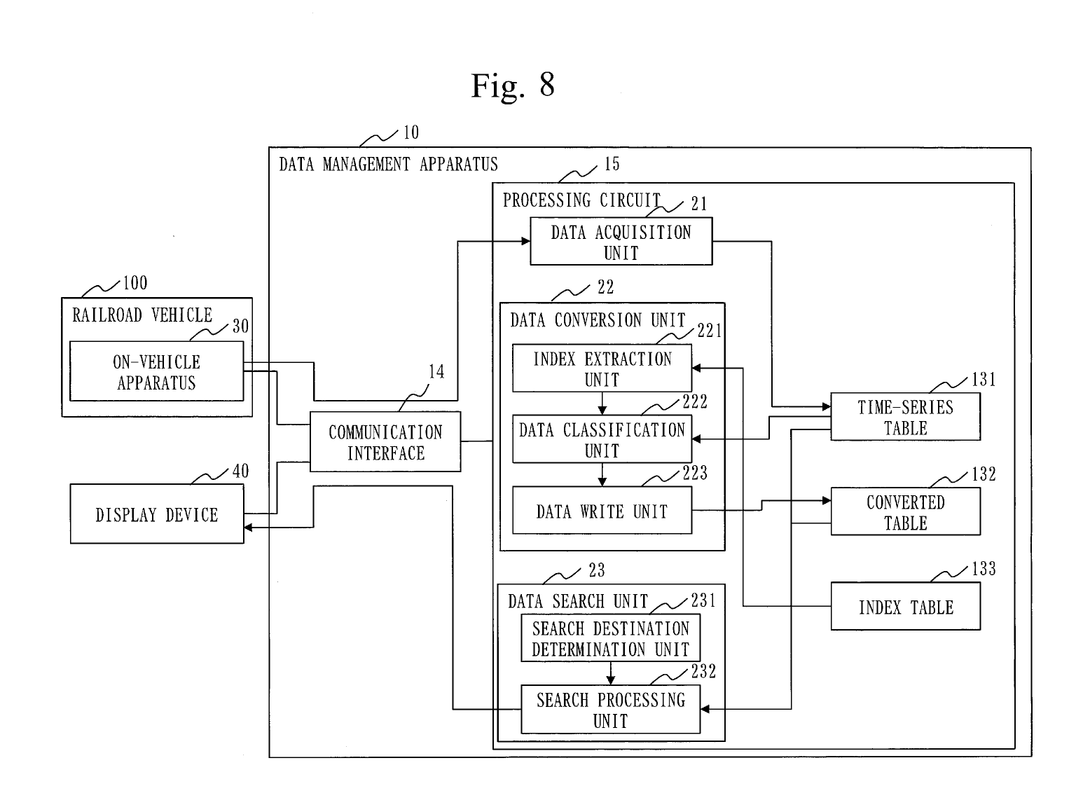

A configuration of the data management apparatus 10 according to the modification example 1 is described with reference to FIG. 8.

In a case where functions of the respective units are implemented by hardware, the data management apparatus 10 includes a processing circuit 15 instead of the processor 11, the memory 12, and the storage 13. The processing circuit 15 is a dedicated electronic circuit which implements the functions of the respective units of the data management apparatus 10 and the functions of the memory 12 and the storage 13.

The processing circuit 15 is assumed to be a single circuit, a composite circuit, a programmed processor, a parallel-programmed processor, a logic IC, a gate array (GA), an application specific integrated circuit (ASIC), or a field-programmable gate array (FPGA).

The functions of the respective units can be implemented by a single processing circuit 15, or the functions of the respective units can be implemented by a plurality of processing circuits 15 in a sharing manner.

### Modification Example 2

As a modification example 2, some function can be implemented by hardware and the other functions can be implemented by software. In other words, some of the functions of the respective units of the data management apparatus 10 can be implemented by hardware and the other functions can be implemented by software.

The processor 11, the memory 12, the storage 13, and the processing circuit 15 are collectively referred to as a “processing circuitry”. In other words, the functions of the respective units are implemented by a processing circuitry.

### Embodiment 2

An embodiment 2 differs from the embodiment 1 in storing data in tables different for each of some classification indexes, such as a railroad business operator. In the embodiment 2, this difference is described.

***Description of Configuration***

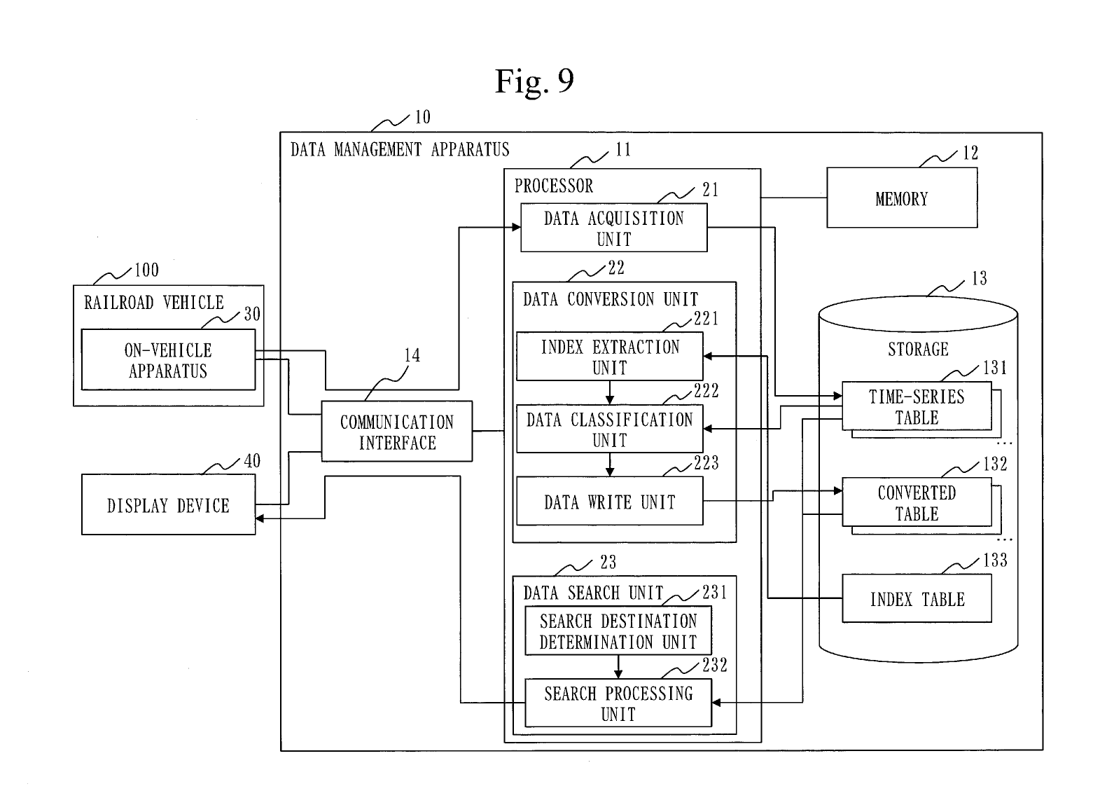

A configuration of the data management apparatus 10 according to the second embodiment is described with reference to FIG. 9.

The data management apparatus 10 illustrated in FIG. 9 differs from the data management apparatus 10 illustrated in FIG. 1 in that each of the time-series table 131 and the converted table 132 is provided for every railroad business operator.

***Description of Operation***

Data acquisition processing according to the embodiment 2 is described with reference to FIG. 2.

In step S12, the data acquisition unit 21 writes data acquired in step S11 into a time-series table 131 corresponding to a railroad business operator associated with a movement location indicated by the acquired data. This causes corresponding pieces of data to be stored in time-series tables 131 provided for the respective railroad business operators.

Data conversion processing according to the embodiment 2 is described with reference to FIG. 4.

In step S24, the data write unit 223 reads out, from the memory 12, data, the number of pieces of which is the reference number, classified into a group corresponding to the target index in step S22, and writes the read-out data as one block into a converted table 132 corresponding to a railroad business operator included in the target index.

Furthermore, in this case, since it is possible to identify data about which railroad business operator the data is, based on a table in which the data has been stored, it is not necessary to store data with involvement of data about a railroad business operator in the time-series table 131 and the converted table 132. However, in a case where not a single railroad business operator but a plurality of railroad business operators manages a line section, information about the railroad business operators which manage the line section is stored.

Moreover, data stored in a time-series table 131 corresponding to a railroad business operator X is relocated to a converted table 132 corresponding to the same railroad business operator X. Therefore, railroad business operators do not need to be included in the classification indexes. Accordingly, a line section, a track number, a movement direction (upbound or downbound), a route version, and a kilometrage, excluding a railroad business operator, are stored in the index table 133.

### Advantageous Effects of Embodiment 2

as described above, in the data management apparatus 10 according to the embodiment 2, data is stored in tables different for every railroad business operator. This enables efficiently reading out data in a case where a railroad business operator is specified as a search condition.

### Other Configurations

### Modification Example 3

In the embodiment 2, a table is divided into tables for the respective railroad business operators. As a modification example 3, a table can be divided into tables with use of another item of the line section data. For example, a table can be divided into tables for the respective railroad business operators and the respective line sections.

In other words, each of the time-series table 131 and the converted table 132 only needs to be divided into tables based on at least any one classification index included in the classification indexes used as data indicating movement locations.

### Modification Example 4

In the embodiment 2, each of the time-series table 131 and the converted table 132 is divided into tables for the respective railroad business operators. However, the data acquisition unit 21 can also be provided for every railroad business operator. Moreover, the data conversion unit 22 and the data search unit 23 can also be provided for every railroad business operator.

### Embodiment 3

An embodiment 3 differs from the embodiments 1 and 2 in that the data management apparatus 10 is mounted on the railroad vehicle 100. In the embodiment 3, this difference is described.

While, in the embodiment 3, a difference from that in the embodiment 1 is described, it is also possible to make a similar change to the embodiment 2.

***Description of Configuration***

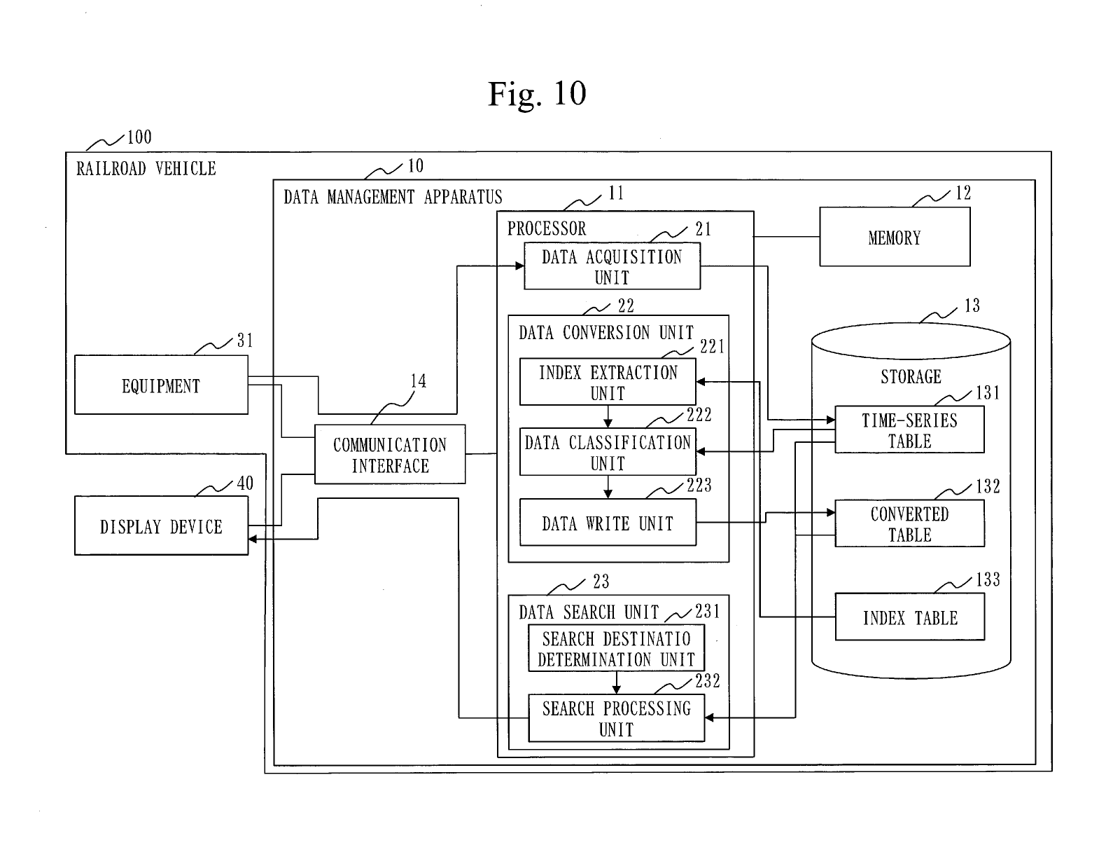

A configuration of the data management apparatus 10 according to the embodiment 3 is described with reference to FIG. 10.

The data management apparatus 10 illustrated in FIG. 10 differs from the data management apparatus 10 illustrated in FIG. 1 in being mounted on the railroad vehicle 100. Moreover, the data management apparatus 10 illustrated in FIG. 10 differs from the data management apparatus 10 illustrated in FIG. 1 in that the data acquisition unit 21 is connected to equipment 31 via the communication interface 14.

***Description of Operation***

Data acquisition processing according to the embodiment 3 is described with reference to FIG. 2.

In step S11, the data acquisition unit 21 collects data concerning the equipment 31 mounted on the railroad vehicle 100 during running of the railroad vehicle 100. Then, in step S12, the data acquisition unit 21 writes the data collected in step S11 into the time-series table 131.

### Advantageous Effects of Embodiment 3

As described above, the data management apparatus 10 according to the embodiment 3 is mounted on the railroad vehicle 100. This enables performing analysis of data in real time.

### Embodiment 4

An embodiment 4 differs from the embodiment 3 in that the data management apparatus 10 acquires data which is managed by a data management apparatus 10 mounted on another railroad vehicle 100. In the embodiment 4, this difference is described.

***Description of Configuration***

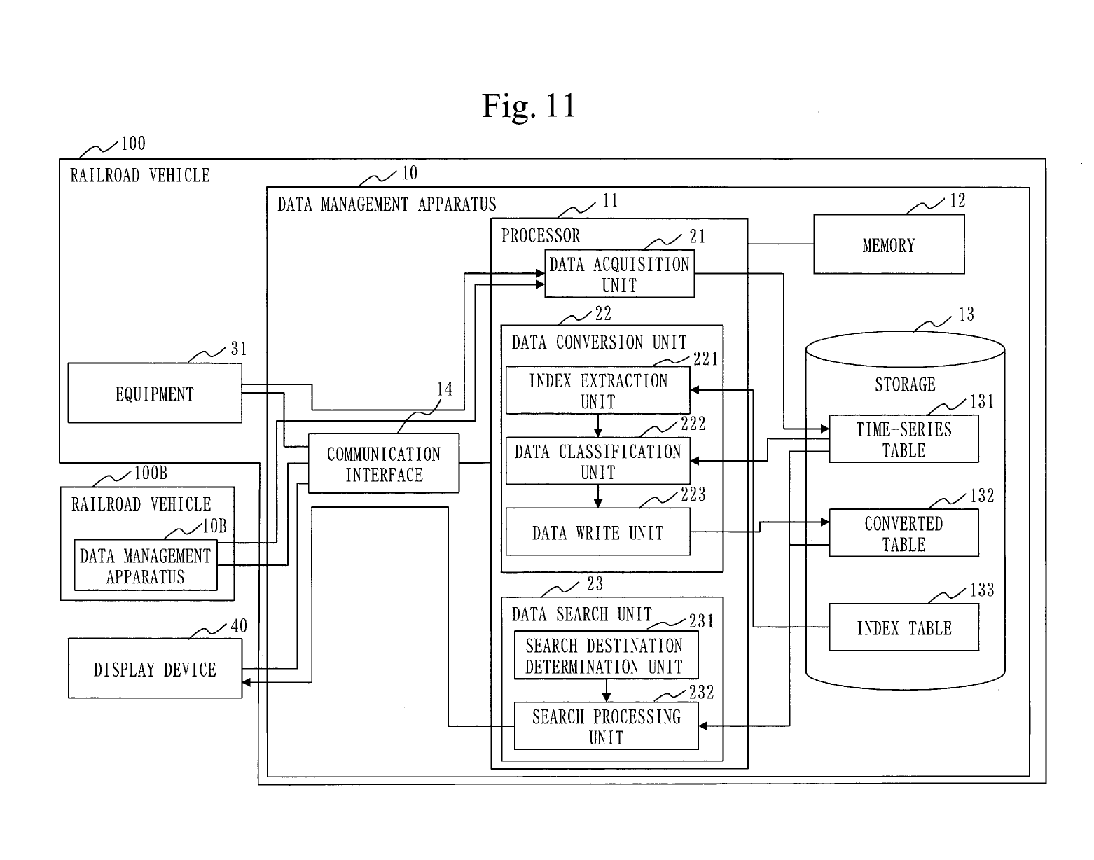

A configuration of the data management apparatus 10 according to the embodiment 4 is described with reference to FIG. 11.

The data management apparatus 10 illustrated in FIG. 11 differs from the data management apparatus 10 illustrated in FIG. 10 in that the data acquisition unit 21 is configured to be able to acquire data from a data management apparatus 10B mounted on a second railroad vehicle 100B via the communication interface 14.

***Description of Operation***

Data acquisition processing according to the embodiment 4 is described with reference to FIG. 2.

In step S11, the data acquisition unit 21 collects data concerning the equipment 31 mounted on the railroad vehicle 100 during running of the railroad vehicle 100. Moreover, the data acquisition unit 21 acquires data concerning equipment mounted on the railroad vehicle 100 from the data management apparatus 10B mounted on the second railroad vehicle 100B. Then, in step S12, the data acquisition unit 21 writes the data collected and the data acquired in step S11 into the time-series table 131.

### Advantageous Effects of Embodiment 4

As described above, the data management apparatus 10 according to the embodiment 4 acquires and manages data which is managed by the data management apparatus 10B mounted on the second railroad vehicle 100B. This enables analyzing data about the equipment 31, including association with data concerning equipment mounted on the second railroad vehicle 100.

As a specific example, it is possible to present such a running method as to optimize the total electricity usage in a line section with use of data about the electricity usage of another train.

### Another Configuration

### Modification Example 5

In the embodiment 4, two data management apparatuses 10 are directly connected to each other. As a modification example 5, a relay server can be provided separately. Then, each data management apparatus 10 can transmit the collected data to the relay server, and, as needed, each data management apparatus 10 can acquire data collected by the other data management apparatus 10 from the relay server.

### REFERENCE SIGNS LIST

10: data management apparatus, 11: processor, 12: memory, 13: storage, 14: communication interface, 15: processing circuit, 21: data acquisition unit, 22: data conversion unit, 221: index extraction unit, 222: data classification unit, 223: data write unit, 23: data search unit, 231: search destination determination unit, 232: search processing unit, 30: on-vehicle apparatus, 31: equipment, 40: display device, 100: railroad vehicle.

1.-9. (canceled)

10. A data management apparatus comprising:
processing circuitry to:
classify pieces of data collected concerning equipment mounted on each of a plurality of moving bodies, which repeatedly move on a same route, during movement of each of the plurality of moving bodies and then stored in a time-series table into a plurality of groups based on a movement location of each of the plurality of moving bodies taken when the pieces of data were collected, such that pieces of data collected at a same movement location, even when collected at different times, are classified into a same group;
write the pieces of data classified into the respective groups into a converted table for every group; and
acquire data matching a search condition from the time-series table with respect to data later than a write point of time of writing of the pieces of data into a storage device and acquire data matching a search condition from the converted table with respect to data earlier than the write point of time.

11. A data management apparatus comprising:
processing circuitry to:
classify pieces of data collected concerning equipment mounted on a moving body, which repeatedly moves on a same route, during movement of the moving body and then stored in a time-series table into a plurality of groups based on a movement location of the moving body taken when the pieces of data were collected;
write the pieces of data classified into the respective groups into a converted table for every group; and
acquire data matching a search condition from the time-series table with respect to data later than a write point of time of writing of the pieces of data into a storage device and acquire data matching a search condition from the converted table with respect to data earlier than the write point of time.

12. The data management apparatus according to claim 10, wherein, when, with respect to each of the groups, the number of pieces of data classified into the group becomes greater than or equal to a reference number, the processing circuitry writes the pieces of data classified into the group into the converted table in a unit of the reference number.

13. The data management apparatus according to claim 10, wherein, in a case where the moving body is a railroad vehicle, the processing circuitry uses at least any one of classification indexes including a railroad business operator, a line section, a track number, a running direction, a route version, and a kilometrage as data indicating the movement location.

14. The data management apparatus according to claim 13, wherein the converted table is divided by at least any one of classification indexes used as data indicating the movement location.

15. The data management apparatus according to claim 10, wherein the data management apparatus is provided separately from the moving body.

16. The data management apparatus according to claim 10, wherein the data management apparatus is mounted on the moving body.

17. The data management apparatus according to claim 16, wherein the processing circuitry collects data concerning equipment mounted on the moving body during movement of the moving body and writes the collected data into the time-series table, and acquires, from a data management apparatus mounted on a different moving body, data collected during movement of the different moving body and writes the acquired data into the time-series table.

18. A non-transitory computer readable medium storing a data management program that causes a computer to perform:
data classification processing to classify pieces of data collected concerning equipment mounted on each of a plurality of moving bodies, which repeatedly move on a same route, during movement of each of the plurality of moving bodies and then stored in a time-series table into a plurality of groups based on a movement location of each of the plurality of moving bodies taken when the pieces of data were collected, such that pieces of data collected at a same movement location, even when collected at different times, are classified into a same group;
data write processing to write the pieces of data classified into the respective groups by the data classification processing into a converted table for every group; and
search processing to acquire data matching a search condition from the time-series table with respect to data later than a write point of time at which the data write processing performed writing into a storage device and to acquire data matching a search condition from the converted table with respect to data earlier than the write point of time.

19. A non-transitory computer readable medium storing a data management program that causes a computer to perform:
data classification processing to classify pieces of data collected concerning equipment mounted on a moving body, which repeatedly moves on a same route, during movement of the moving body and then stored in a time-series table into a plurality of groups based on a movement location of the moving body taken when the pieces of data were collected;
data write processing to write the pieces of data classified into the respective groups by the data classification processing into a converted table for every group; and
search processing to acquire data matching a search condition from the time-series table with respect to data later than a write point of time at which the data write processing performed writing into a storage device and to acquire data matching a search condition from the converted table with respect to data earlier than the write point of time.
